(19) United States
(12) Patent Application Publication
(10) Pub. No.: US 2005/0104005 A1
(43) Pub. Date: May 19, 2005

(54) Gaseous detector imaging device and surgical installation including such device

(76) Inventors: Garth Cruickshank, Birmingham (GB); Claude Hennion, Paris (FR); Joe Dickinson, Jersey (GB); David B Naylor, Cheam Surrey (GB)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/482,902

(22) PCT Filed: Jul. 2, 2002
(86) PCT No.: PCT/EP02/07268

(30) Foreign Application Priority Data
Jul. 5, 2001 (EP) 01401805.5

(51) Int. Cl. G01T 1/18

(52) U.S. Cl. 250/382

(57) ABSTRACT

A gaseous detector comprising a pressurized vessel full of a ionizable gas having a pressure of 10 bar, a large number of electrodes contained in the pressurized vessel, an electric supply connected to the electrodes to create an electric field in the vessel, and an electronic front end circuitry having several separate inputs connected individually respectively to said electrodes, for receiving signals generated by said electrodes when detecting ionizing rays. The electronic front end circuitry is contained in the pressurized vessel.

### FIELD OF THE INVENTION

The present invention relates to multi-wire imaging devices and to surgical installations including such imaging devices.

### BACKGROUND OF THE INVENTION

More particularly, the invention relates to a gaseous detector imaging device including at least a first gaseous detector for detecting ionizing rays in a first detection direction and a display device communicating with said first gaseous detector for producing an image from the detected ionizing rays, said gaseous detector comprising:
a pressurized vessel full of a ionizable gas having a pressure of at least 5 bar, said vessel being at least partially transparent for ionizing rays,
at least an array of at least 100 electrodes contained in the pressurized vessel,
an electric supply connected to at least part of said electrodes to create an electric field in the vessel, such that when a ionizing ray of sufficient energy ionizes the gas in said pressurized vessel, said electric field generates an electron avalanche detected by said electrodes,
an electronic front end circuitry having several separate inputs connected individually respectively to said electrodes, for receiving signals generated by said electrodes when detecting ionizing rays, said electronic front end circuitry further having an output communicating with the display device, said electronic front end circuitry being adapted at least for computing positions of detected ionizing rays in said image and for transmitting at least said positions to the display device.

Document EP-A-0 855 086 describes an example of such an imaging device, which is efficient and accurate, and in which the front end circuitry is outside the pressurized vessel.

However, imaging devices of this type are complex, bulky and costly to manufacture.

An object of the present invention is to remedy these drawbacks.

To this end, according to the invention, in an imaging device of the kind in question, the electronic front end circuitry is contained in the pressurized vessel.

Thanks to these dispositions, the wall of the pressurized vessel has to be traversed only by high voltage electric conductors and by a few electric communication conductors connected to the output of the electronic front end circuitry (these communication conductors could possibly be omitted and be replaced by a contactless communication link). For instance, one may use 2 communication conductors in case of a serial output, or possibly 8 communication conductors in case of an 8 bit parallel output. In any case, the number of conductors going through the wall of the pressurized vessel is largely reduced compared to the prior art gaseous imaging devices, so that ensuring the tightness of the vessel is much less costly in the present invention.

Further, the above dispositions also enable to greatly simplify the electric connections between the electrodes and the front end circuitry. In particular, the length of electric conductors between the electrodes and the front end circuitry is sharply reduced.

Also, providing the front end circuitry inside the pressurized vessel makes the detector less bulky and protects this circuitry against damages by mechanical contacts. Conversely, the disposition of the front end circuitry in a high pressure environment with ionization phenomena proved to have no detrimental effects on the proper operation or life time of this circuitry.

Finally, it should be noted that the imaging device according to the invention is lightweight and of small dimensions, enabling it to be portable while being very precise. This portability enables to bring nuclear medicine imaging to the patients and to the surgery theaters-rather than bringing the patients to a nuclear medicine imaging installation, which greatly facilitates the use of nuclear medicine imaging.

In various embodiments of the imaging device according to the invention, one may further use one and/or the other of the following dispositions:
the output of the electronic front end circuitry communicates with the display device through less than ten conductors;
the output of the electronic front end circuitry communicates with the display device through at most three conductors;
the electronic front end circuitry includes analog circuits connected to the electrodes of the gaseous detector for receiving said signals generated by said electrodes when detecting ionizing rays, and a digital circuit connected to the analog circuits for computing at least the position of each detected ionizing ray in the image and for transmitting at least said position to the display device;
the pressurized vessel includes at least a conversion zone in which the gas is ionized by said ionizing rays, an amplification zone in which said electron avalanches are generated, and a circuitry zone which contains the electronic front end circuitry and which is separated from said conversion zone and from said amplification zone by at least part of said electrodes;
said electrodes include at least a first array of threadlike electrodes all extending in a first direction and in a first plane, and a second array of threadlike electrodes all extending in a second direction different from said first direction and in a second plane different from said first plane, the electrodes of said first array being at a first electric potential and the electrodes of said second array being at a second electric potential different from said first potential, said amplification zone being comprised at least between said first and second arrays, said conversion zone being separated from the circuitry zone by the amplification zone and said circuitry zone being separated from the amplification zone by said second array;
the pressurized vessel further contains a grid of wires in a third plane parallel to said first and second planes, the first array being situated between said grid and the second array, said grid being at said second electric potential and separating the conversion zone from the amplification zone, the wires of said grid all extending in said second direction;
said second array includes a plate having a face oriented toward the amplification zone, said face having conductor strips constituting the electrodes of said second array; said electrodes of each array are disposed at a pitch of 0.5 to 1.5 mm;
the gas contained in the pressurized vessel includes between 85 and 95% of xenon and between 5% and 15% of ethane;
the imaging device is portable and said vessel has dimensions which are all less than 40 cm in three perpendicular directions;
said vessel is made of at least a material chosen between carbon fiber, aluminum and Kevlar@.

Besides, another object of the invention is a surgical installation including a surgical theater and an imaging device as described above, the first gaseous detector of said imaging device being mounted so that the first detection direction of said first gaseous detector may be oriented toward the surgical theater.

In various embodiments of the surgical installation according to the invention, one may further use one and/or the other of the following dispositions:
the first gaseous detector is fixed to a surgery table;
the first gaseous detector is supported by a frame which is removably fixed to the surgery table;
said frame includes a head support adapted to support the head of a patient during cerebral surgery;
said frame includes a collimator interposed between said first gaseous detector and said head support;
the imaging device further includes a second gaseous detector similar to said first gaseous detector and having a second detection direction, said second detector being mounted to the surgery table so that the second detection direction may be oriented toward the surgical table at an angle with said first detection direction, said second gaseous detector communicating with the display device and said display device being able to compute a three dimensional image at least from images taken by said first and second gaseous detectors.

### BRIEF DESCRIPTION OF THE DRAWINGS

Other features and advantages of the invention will appear from the following description of several of its embodiments, given by way of non limiting examples, with regard to the appended drawings.

In the drawings:

FIG. 1 is a perspective view diagrammatically showing a surgical installation fitted with an imaging device according to a first embodiment of the invention,

FIG. 2 is an exploded view of the gaseous detector belonging to the imaging device of FIG. 1,

FIG. 3 is a diagrammatical view showing part of the electrodes of the detector of FIG. 2,

FIG. 4 is a block diagram showing a front end circuitry contained in the gaseous detector of FIG. 2,

FIGS. 5 and 6 show examples of diagrams illustrating how the invention may be used to monitor the excision of a tumor,

and FIGS. 7 and 8 diagrammatically illustrate two variants of the surgical installation according to the invention.

### MORE DETAILED DESCRIPTION

In the drawings, the same references designate identical or similar elements.

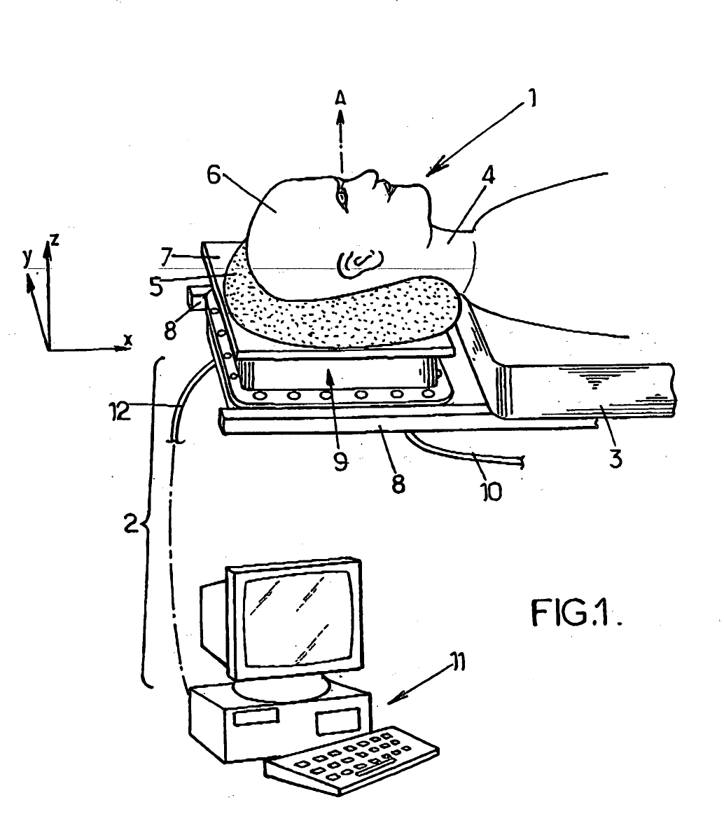

FIG. 1 diagrammatically shows a surgical installation comprising a surgical theatre 1 and an imaging device 2 adapted for taking nuclear medicine images of a patient in the surgical theater.

In the example shown in FIG. 1, the surgical theatre includes a surgical table 3 which is adapted to support the patient 4 in a longitudinal horizontal direction X. More particularly, in the example shown, the surgical table 3 is adapted for cerebral surgery and includes a special horse shoe headrest 5 adapted to maintain the head 6 of the patient during the surgical operation. However, the invention could be used with other head supports such as a conventional 3-pin head support, a relocatable mask stereotactic arc, etc.

In the example of FIG. 1, the headrest 5 is supported by a pierced metal plate 7 constituting a collimator. The collimator 7 is itself supported by a frame 8, which is only partially visible on FIG. 1 and which is removably mounted on the surgical table 3.

The frame 8 also supports a gaseous detector 9 which, in the example of FIG. 1, is adapted to take 2-dimension images of the patient's brain in a detection direction A (parallel to the vertical axis Z in the present case) through the collimator 7, by detecting ionizing rays and more specially gamma rays which are emitted by a radiotracer such as thallium 201 or tantalum 178. The radiotracer is grafted on a pharmaceutical which is given to the patient and which is designed to be uptaken specifically by a predetermined organ or lesion such as tumor. For instance, intrinsic brain tumors, gliomas, and most metastases to the brain from systemic cancers will show selective uptake of thallium 201 isotope to give a difference in gamma activity emitted from 2.5:1 for high grade tumors to 1.5:1 for low grade lesions.

The frame 8 may advantageously be conceived so that the gaseous detector 9 may be adjusted:
by sliding in the X direction,
and/or by sliding in a horizontal direction Y which is transverse to the X axis,
and/or by sliding in the vertical direction Z toward and away from the collimator 7, or by sliding vertically with said collimator 7 toward and away from the headrest 5,
and/or by pivoting around one or several axis.

The gaseous detector 9 has a high voltage cable 10 supplying for instance an electric voltage comprised between 2000 and 2500 volts or other voltage values, and said gaseous detector is connected to a display device such as micro-computer 11 through a communication cable 12.

Thus, the micro-computer 11 may compute and treat the images of the patient's brain, and more particularly, for instance, of a tumor to be excised in the patient's brain, starting from the gamma ray detections which are transmitted to computer 11 through the communication cable 12.

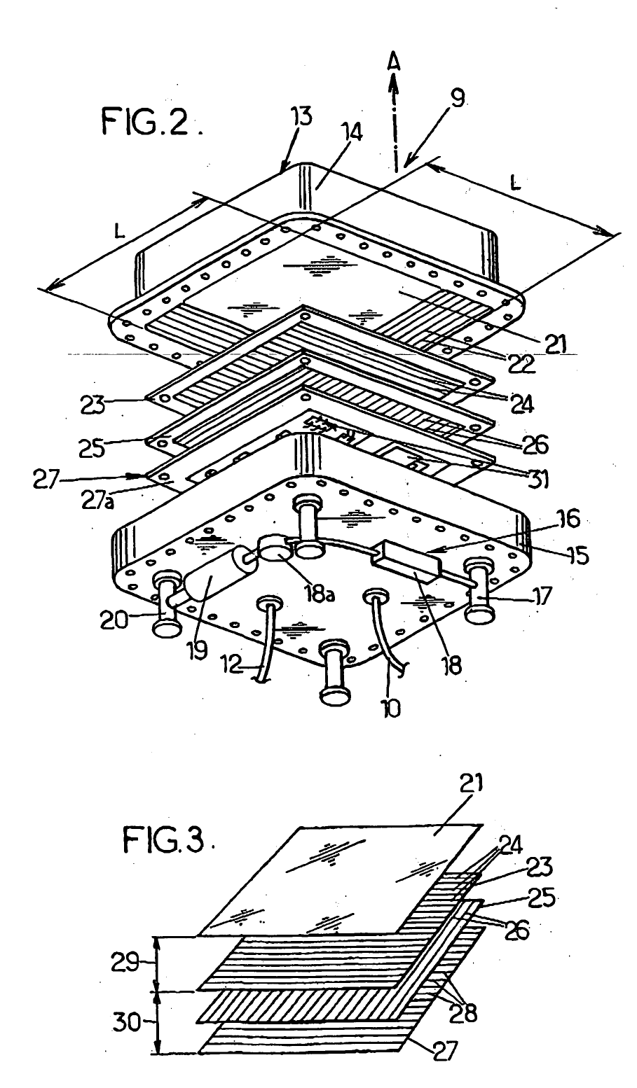

The gaseous detector 9 is shown in more details in FIG. 2. This detector includes a pressurized vessel 13 which is full of ionizable gas under a pressure, comprised for instance between 5 and 15 bar and advantageously of about 10 bar. The ionizable gas may include xenon, and may in particular include between 85 and 95% of Xenon and between 5 and 15% of ethane (for instance, about 90% of xenon and 10% of ethane). Of course, other gases or gas mixtures could be used.

The pressurized vessel 13 is preferably made out of carbon fiber composite, or may also be made out of aluminum or Kevlar®.

This pressurized vessel 13 includes a cover 14 which is tightly bolted or fixed in another way to a bottom 15. At least the front wall of the cover (i.e. the wall of the cover which is parallel to the bottom) is transparent to the ionizing rays to be detected.

The internal cavity defined by the vessel 13 has a width L and a length L of about 25 cm in a plane perpendicular to the detection direction A, in the example shown in the drawings. The depth of the internal cavity of the vessel 13 may be for instance of about 20 cm in the detection direction A.

The overall dimensions of the detector 9 are all less than 40 cm in the X, Y and Z directions, and its overall weight is less than 3.5 kg when made out of carbon fiber composite.

The bottom 15 of the pressurized vessel may be equipped with a gas circuit 16 situated for instance outside the pressurized vessel, for recirculating and purifying the ionizable gas contained in the pressurized vessel. This gas circuit 16 may include for instance a gas outlet 17, a flow meter 18, a recirculating pump 18a, a gas purifier 19 and a gas inlet 20. The gas outlet and the gas inlet communicate with the internal cavity of the pressurized vessel.

Further, the pressurized vessel 13 contains a large number of electrodes as will be explained hereafter. These electrodes may be designed according to several known dispositions, as described for instance in FR-A-2 739 941, FR-A-2 749 402 or FR-A-2 754 068.

In the particular example which is clearly visible on FIGS. 2 and 3, these electrodes include:
a drift cathode 21 at negative electric potential, constituted for instance by a thin layer of gold evaporated on a glass plate (not shown) which is fixed under the front wall of the cover 14,
annular field shaping electrodes 22, constituted by wires forming loops around the internal cavity of the pressurized vessel perpendicularly to the A direction, said field shaping electrodes being at negative electric potential,
a grid 23 including a frame and a large number of thin wires 24, all in the same direction and in a plane which is perpendicular to detection direction A, the grid 23 being at negative electric potential,
a first array 25 of electrodes 26 constituted by thin wires extending all in the same direction, in a plane parallel to grid 23 and situated under grid 23, the direction of wires 26 being preferably perpendicular to the direction of wires 24 and said first array 25 being at a positive potential,
and a second array 27 of electrodes, which is formed by an insulating solid plate 27a disposed parallel to the array 25 and to the grid 23, said plate being situated under the first array 25 and having an upper surface on which are printed conductor strips 28 constituting electrodes which all extend parallel to the wires 24 and which are at a negative potential.

The above positive and negative potentials are supplied by the high voltage cable 10, the difference between the positive and negative potentials being for instance of 2500 volts.

In the example shown in the drawings, the first array of electrodes 25 includes 192 wires, and the second array 27 of electrodes includes 192 conductor strips. More generally, a gaseous detector according to the invention will always include at least 100 electrodes forming one or several arrays, and preferably at least 300 electrodes forming one or several arrays.

The drift cathode 21 delimitates with the field shaping electrode 22 and the grid 23, a drift and conversion zone 29 in which the incident gamma photons ionize the gas after traversing the cover 14 of the pressurized vessel, the drift cathode 21 and the glass plate supporting said drift cathode. This drift and conversion zone may for instance have a depth of about 52 mm in the A direction.

Besides, the space comprised between the grid 23 and the second array 27 constitutes an amplification zone 30 in which electrons avalanches are created by electrons which have been liberated due to the ionization of the gas by the incident gamma rays.

The distance between the grid 23 and the first array 25 may for instance be of about 3 mm and the distance between the first array 25 and the second array 27 may be for instance of about 1 mm. The pitch of the wires in the grid 23 and the first area 25 may be for instance of about 1.27 mm, or more generally comprised between 0.5 and 1.5 mm. The diameter of these wires may be for instance of about 0.8 mm. the conductor strips of the second array may be for instance about 1.1 mm width, and they can be separated from one another for instance by separations of about 0.8 mm.

Besides, as can be seen on FIG. 2, the pressurized vessel 13 further contains an electronic front end circuitry 31, which is preferably disposed under the plate 27a of the second array 27, i.e. between said plate 27a and the bottom 15 of the vessel. The energy supply of circuitry 31 may be derived from the high voltage supplied by cable 10.

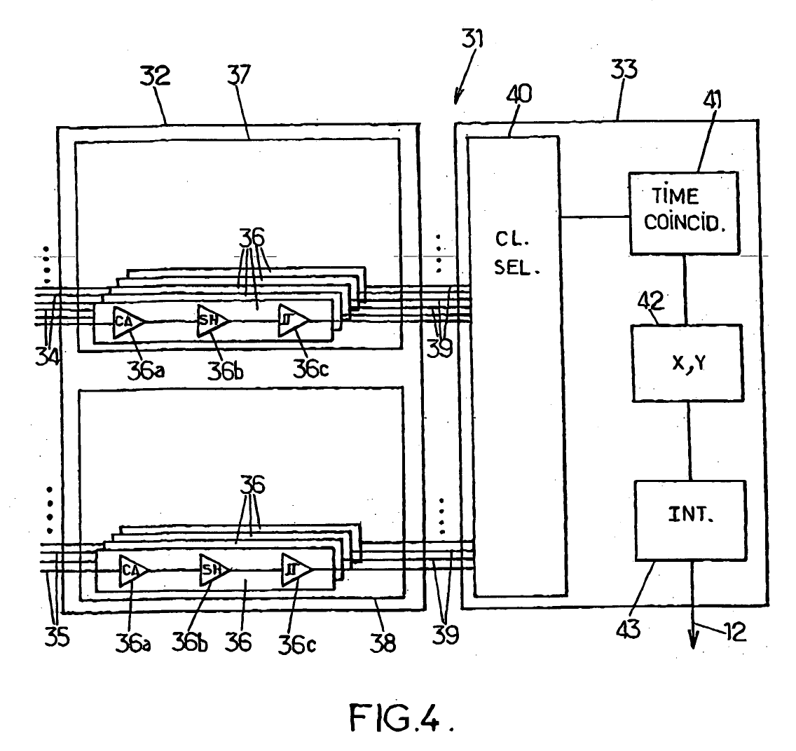

As shown on FIG. 4, the electronic front end circuitry 31 may include an analog circuitry 32 and a digital circuit 33.

The analog circuitry 32 includes a first assembly 37 of analog circuits 36 connected respectively to the output conductors 34 of the respective electrodes 26 of the first array 25, and a second assembly 38 of analog circuits 36 which are connected respectively to the output conductors 35 of the respective electrodes 28 of the second array 27.

Each analog circuit 36 may count for instance up to 1010 hits per second on each electrode and may include for instance a charge amplifier 36a, a shaper 36b and a discriminator 36c, the outlet 39 of which is connected to the digital circuit 33, which may be for instance an ASIC (but could also be or include a programmed microprocessor).

The outlets 39 may be for instance connected to a cluster selector circuit 40 which eliminates part of the events detected by the gaseous detector 9. For instance, the cluster selector circuit 40 eliminates events which correspond to clusters of detected pulses which are spread across more than three adjacent electrodes in each direction.

The cluster selector circuit 40 communicates with a time coincidence selector circuit 41 which checks that signals read from the electrodes 26, 28 occur within a specified time window, to ascertain that they originate from the same photons detection.

If these criteria are met by the detected event, then the X, Y coordinate allocation circuit 42 compute the coordinates of the detected ionizing ray in the image, i.e. in the plane X, Y. In this computation, it is possible to linearly combine signals received from adjacent electrodes, to further improve the resolution of the detector. The resolution thus obtained is of about 1 mm.

Once these coordinates have been computed, they are transmitted to the micro-computer 11 through an interface circuit 43 and cable 12.

Cable 12 may include for instance only two conductors, in which case the bits constituting the information to be transmitted to the computer are transmitted in series, one after the other.

As a variant, the cable 12 could include for instance between 2 and 10 conductors, advantageously 8 conductors, to transmit the information in octets.

It should be noted that the walls of the pressurized vessel are traversed only by the high voltage cable and by the conductors of communication cable 12. Due to the low number of conductors which have thus to go through the walls of the pressurized vessel 13, the cost for ensuring the tightness of the vessel remains limited.

The imaging device which have been described above may be used during surgery, for instance during a tumor excision, to ascertain that the complete tumor has been excised, while minimizing the excision of sane brain tissues.

This is made possible by the small size of the detector according to the invention and by its precision and rapidity (30 s or less are necessary to realize an image), which enables to use it during surgery so as to monitor in real time the quantity and position of tumor tissues remaining to excise. This real time monitoring is all the more important as it is not possible to rely upon radio images taken prior to surgery as far as brain surgery is concerned, since the brain tissues are soft and move during the tumor excision.

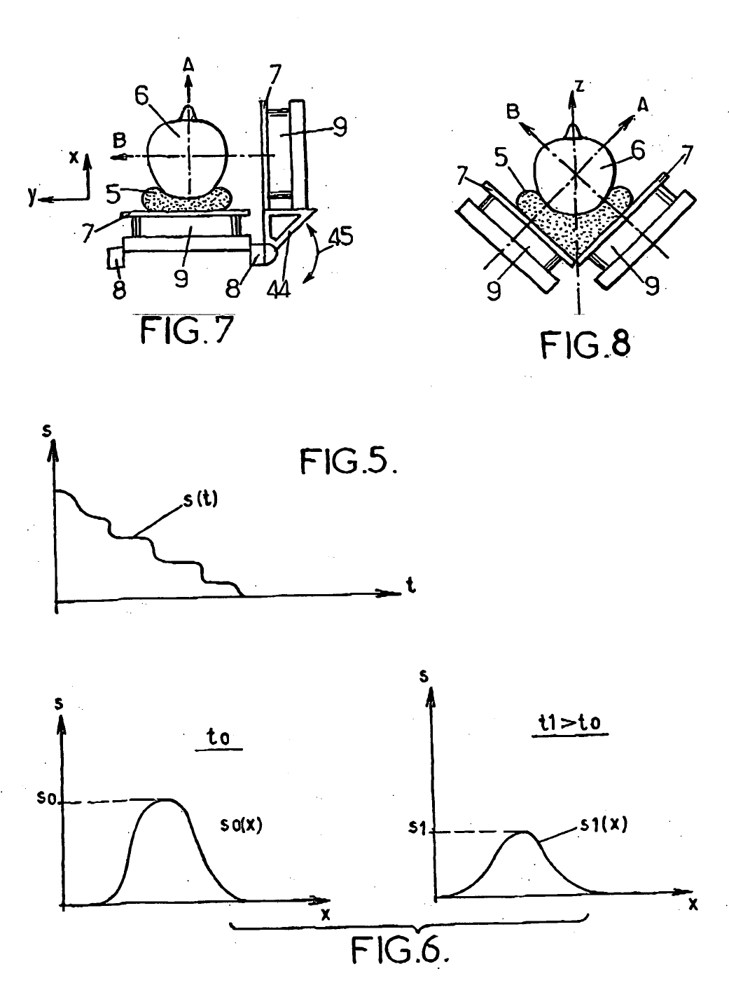

This real time monitoring may be carried out for instance by viewing the image of the remaining tumor on the screen of the micro-computer 11 during surgery, and/or the micro-computer 11 may compute curves such as the curve shown in FIG. 5, representing the amplitude of the signal s coming from the detector 9 in a particular area of the image as a function of time. This amplitude is a function of the number of gamma ray hits detected in the area to be studied, and thus reflects the quantity of tumor which is still present in said area.

This signal s(t) decreases progressively during excision of the tumor, and becomes substantially equal to 0 when the tumor has been completely excised.

As a variant, the micro-computer 11 may also compute curves such as those shown on FIG. 6, showing the amplitude of the signal s coming from the detector 9 as a function of the position x of each pixel in the image. These curves may be computed for instance at a time t0 before surgery, where the curve s0(x) has a maximum S0, and at several instants t1 during surgery, where the signal s1(x) has a maximum S1 which progressively decreases and which becomes equal to 0 when the tumor has been completely excised. Advantageously, the curves of FIG. 6, which are given each for a single y coordinate, can be computed for several y coordinates, or the micro-computer can even calculate and display surfaces s(x, y) at time t0 and for several instants t1 during surgery.

Advantageously, the surgical installation could include two or more detectors 9 having non parallel detecting directions A, B, preferably perpendicular to one another, as shown on FIG. 7, so as to be able to compute a 3-dimensional image of the brain of the patient, possibly by combining the two 2-dimension images taken by these detectors with a three dimension radio image made for instance by CT or MRI scan prior to surgery.

As shown in FIG. 7, in this case, one of the gaseous detectors 9 may be mounted as previously described, while the second gaseous detector may have its detecting direction B parallel to axis Y, and this gaseous detector may be mounted for instance on a support frame 44 which is rotatively mounted on frame 8 or on the surgery table so as to be able to rotate in the direction of arrows 45: thus, the second gaseous detector 9 may be retracted for instance under the surgical table or under the first gaseous detector 9 to avoid hindering the surgical team when not in use.

In another variant, shown in FIG. 8, the two gaseous detectors 9 could have their detection directions A, B oriented upwardly at 45 from the vertical direction Z.

Summarizing, one of the major values of the device described above is to enhance the capacity of the surgeon to achieve greater and more comprehensive tumor excision in a situation which provides for the first time, real time peroperative feedback of the extent of biologically relevant tumor present.

As a matter of fact, CT or MRI scans only show morphological components of tumors. Further, CT and MRI scanning are mostly performed prior to surgery and hence do not provide up to the minute indications of tumor present. Where per-operative MRI is available there are delays in achieving image capture, distortions to images from any magnetic or paramagnetic source, axial field distortions giving aberrant dimensional errors. Most importantly, so-called real-time MRI cannot reveal the important biological volume of the tumor, only the morphological features, which reflect distortions due to prior treatment, tumor swelling and dead tumor rather than indicating the viable biological target tumor volume.

This real time operative imaging device, by providing rapid contemporaneous and continuously updated images, will enable the surgeon to excise a greater and potentially more therapeutic proportion of the tumor in a consistent and reliable way.

In addition, information derived from CT, MRI and fMRI imaging can be used in conjunction with the output of the gaseous detector according to the invention.

Examples of general applications of the imaging device according to the invention are as follows:
1. Detection of relative uptake of target organs, tissues or pathological disease areas or processes, of a specific isotope system or isotope labeled ligand system, allowing high speed real time definition and resolution with a linearity of response allowing measurement of both volume and specific activity of the target cells, displayed as a two or three dimensional quantitative visual image, in animals or humans.
2. Concurrent analysis of more than one isotope or labelled isotope system, based on energy level discrimination.
3. Fusion of images taken by the imaging device according to the invention with other images to achieve precise anatomical coincidence of measured activity to anatomical, and morphological sites indicated by Magnetic Resonance Imaging (MRI), Computerized Axial Tomography (CAT), Ultrasound, Single Photon Emission Tomography (SPECT/SPET), Positron Emission Tomography (PET), Magnetic Intensity Devices (IMR, MEG), and other devices dependent on the imaging of X-ray, visual (microscope), or extra visual wavelengths (Near Infra-Red).
4. Analyze of existing commercially available or novel isotopes, labeled ligands, and labeled drugs of energies from more than 511 Kev down to as low as 40 Kev.
5. Imaging and quantitation applied to regions of the human body such as the head and brain, neck, thorax and contents including thoracic wall, breast tissue, lungs, cardiac and pericardial components, and associated vascular structures, abdominal and pelvic regions and contents and visualization of tissues and vascular structures of the limbs.
6. Analysis of components in the normal and pathological states, with particular reference to ischaemic, infective, oncological, degenerative and traumatic processes.
7. Imaging of large, medium and small (tissue level) vascular structures in the brain and their allied parenchyma, for the purposes of detecting normal perfusion, ischaemia and hyperaemia, in normal and pathological states: this utilizes the unique ability of the detector device according to the invention to count rapidly all incident gamma radiation, from point sources dependent on position, concentration and activity, at high resolution using low energy isotope or labeled ligands systems, in short periods of time allowing rapid sequence analysis through multiple dosing and imaging, of dynamic pathological changes or therapeutic responses, without delay problems, and at very low absorbed radiation doses, even in iterative dosing schedules.
8. Near real-time analysis of brain status in ischaemic, traumatic and neurosurgical patients, to follow pathology and response to therapeutic maneuvers, eg improvement in tissue perfusion after thrombolysis in cerebrovascular accident (stroke), improvement in brain perfusion and/or metabolism after relief of raised intracranial pressure, or elevation of cerebral perfusion pressure, in trauma or subarachnoid haemorrhage.
9. Measure and visualization of lesions in the brain such as tumors, to determine tumor load, and to in real time and delayed time coincidentally image therapeutic instruments such as drugs and their distribution to the imaged tumor (coverage), gene therapy, radiation (vide infra), thus enabling confirmation of access, early detection of response, and proof of mechanistic principle, in such a way as to accelerate development and reduce costs in the introduction of new treatments, whilst allowing reduction of risks to the patient.
10. Imaging required for radiotherapeutic and linear accelerator (LINAC) or Gamma Knife (Cobalt) stereotactic radio-surgical (SRS) (single-shot) or stereotactic radiotherapeutic (SRT) (fractioned treatment) or conformal SRT planning, including intensity modulated radiotherapy (IMRT) to determine target size, target volume and dosage distribution.
11. Measure of direct radiation applied, and dosage delivered.
12. Boron Neutron Capture to determine the gamma product of the secondary reaction after the initial N-a reaction as a stoichiometric measure of received radiation dose to tumor and/or tissue in the brain and other sites as indicated above, thus providing a real-time measure and image of dose distribution and dose received, and solving one of the major problems in determining microdose prescription, and radiation injury in this novel but complex treatment. This will enable BNCT to be used more widely and as safely or moreso, as conventional radiation methods.
13. Detection, diagnosis, image directed surgery, and image directed treatment of diseases of the ear, nose and throat with particular reference to oncology.
14. Detection, diagnosis, image directed surgery, and image directed treatment of diseases of the Kidney with particular reference to oncology.
15. Detection, diagnosis, image directed surgery, and image directed treatment of diseases of the Thyroid gland with particular reference to oncology.
16. Detection, diagnosis, image directed surgery, and image directed treatment of diseases of Bone with particular reference to bone density, oncology, and joint disease.
17. Application, either singly or in optimized conjunction to image Lung, Breast, and GIT for the detection of, and screening for malignancy using both the principle methods of unselective relative isotopic activity uptake, and selective specific targeting with directed labeled ligands, based on the high sensitivity and resolution afforded by the performance of the detector device according to the invention, thereby offering the possibility of improved early detection over existing methods, such as chest X-ray, mammography or bowel series X-rays or endoscopy, in a more reliable cost effective manner, acceptable to patients, and using a device and protocol allowing mass use at low cost levels.
18. Imaging of cardiac tissue function and pump performance in real or near real-time to visualize and quantitate heart perfusion, cardiac output, and ventricular ejection fractions at rest and during exercise.
19. Analysis of cardiopulmonary performance of right and left ventricles at rest and during exercise.
20. Imaging of cardiac tissue in cardiomyopathy, heart failure, situations of ischaemia, valvular dysfunction, and hibernation both acutely and episodically.
21. Assessment of cardiac performance and cardiac tissue in painful and non-painful ischaemic states to elucidate recoverable or salvageable muscle tissue.
22. Cardiac monitoring of patients in the ITU setting by virtue of the unique portability of the detector system according to the invention.
23. Quantitative cardiac monitoring and visualization in patients undergoing existing or novel treatments, at various time intervals.
24. Analysis of cardiac function and performance in the operating theatre in real time during surgical manipulation of the heart.
25. Visualization of dopaminergic cell numbers in patients with Parkinson's Disease, at optimal intervals and during therapeutic intervention including antiparkinsonian drug treatment, lesion making, gene therapeutic manipulation of stem or other cells, syngeneic or xenografted dopaminergic cell transplantation including embryonal cells and their persistence.
26. Co-imaging using multiple isotope systems and/or labeled ligands to image the therapeutic agents, cells, or gene therapy mechanism in relation to location and function of relevant neural substrates including dopaminergic cells, to exact dynamic assessment of disease and treatment response to correlate with clinical performance in the development of new treatment strategies.
27. Novel cancer treatments in Lung, Breast, Ovary, GIT, Prostate and Brain where imaging and quantitation of disease load and extent can be followed together with the imaging and quantitation (location, activity and extent of coverage) of the tumor by the treatment agent: transfected gene therapy, stem cell or altered cell function, drug disposition, radiation effect (vide supra BNCT) to verify mechanism, access and delivery, to correlate with clinical response and rapidly, reliably and safely analyze efficacy, and accelerate the introduction and of new agents in a cost effective and widely accessible way.

Besides, it should be noted that, independently of what was previously described and of what is claimed hereunder, the front end circuitry could also be contained in a portion of the vessel 13 which would be at atmospheric pressure and which would communicate or not with the atmosphere, instead of being contained in the pressurized inner space of the vessel. In such a case, the other dispositions previously described could remain the same.

1. A gaseous detector imaging device including at least a first gaseous detector for detecting ionizing rays in a first detection direction and a display device communicating with said gaseous detector for producing an image from the detected ionizing rays, said first gaseous detector comprising:
a pressurized vessel full of a ionizable gas having a pressure of at least 5 bar, said vessel being at least partially transparent for ionizing rays,
at least an array of at least 100 electrodes contained in the pressurized vessel,
an electric supply connected to at least part of said electrodes to create an electric field in the pressurized vessel, such that when a ionizing ray of sufficient energy ionizes the gas in said pressurized vessel, said electric field generates an electron avalanche detected by said electrodes,
an electronic front end circuitry having several separate inputs connected individually respectively to said electrodes, for receiving signals generated by said electrodes when detecting ionizing rays, said electronic front end circuitry further having an output communicating with the display device, said electronic front end circuitry being adapted at least for computing positions of detected ionizing rays in said image and for transmitting at least said positions to the display device, characterized in that the electronic front end circuitry is contained in the pressurized vessel.

2. An imaging device according to claim 1, wherein the output of the electronic front end circuitry communicates with the display device through less than ten conductors.

3. An imaging device according to claim 2, wherein the output of the electronic front end circuitry communicates with the display device through at most three conductors.

4. An imaging device according to claim 1, wherein the electronic front end circuitry includes analog circuits connected to the electrodes of the gaseous detector for receiving said signals generated by said electrodes when detecting ionizing rays, and a digital circuit connected to the analog circuits for computing at least the position of each detected ionizing ray in the image and for transmitting at least said position to the display device.

5. An imaging device according to claim 1, wherein the pressurized vessel includes at least a conversion zone in which the gas is ionized by said ionizing rays, an amplification zone in which said electron avalanches are generated, and a circuitry zone which contains the electronic front end circuitry and which is separated from said conversion zone and from said amplification zone by at least part of said electrodes.

6. An imaging device according to claim 5, wherein said electrodes include at least a first array of threadlike electrodes all extending in a first direction and in a first plane, and a second array of threadlike electrodes all extending in a second direction different from said first direction and in a second plane different from said first plane, the electrodes of said first array being at a first electric potential and the electrodes of said second array being at a second electric potential different from said first potential, said amplification zone being comprised at least between said first and second arrays, said conversion zone being separated from the circuitry zone by the amplification zone and said circuitry zone being separated from the amplification zone by said second array.

7. An imaging device according to claim 6, wherein the pressurized vessel further contains a grid of wires in a third plane parallel to said first and second planes, the first array being situated between said grid and the second array, said grid being at said second electric potential and separating the conversion zone from the amplification zone, the wires of said grid all extending in said second direction.

8. An imaging device according to claim 6, wherein said second array includes a plate having a face oriented toward the amplification zone, said face having conductor strips constituting the electrodes of said second array.

9. An imaging device according to claim 6, wherein said electrodes (26, 28) of each array are disposed at a pitch of 0.5 to 1.5 mm.

10. An imaging device according to claim 1, wherein the gas contained in the vessel includes between 85 and 95% of xenon and between 5% and 15% of ethane.

11. An imaging device according to claim 1, constituting a portable imaging device wherein the pressurized vessel has dimensions which are all less than 40 cm in three perpendicular directions (X, Y, Z).

12. An imaging device according to claim 1, wherein the pressurized vessel is made of at least a material chosen between carbon fiber, aluminum and Kevlar®.

13. A surgical installation including a surgical theater and an imaging device according to claim 1, the first gaseous detector of said imaging-device being mounted so that the first detection direction of said first gaseous detector may be oriented toward the surgical theater.

14. A surgical installation according to claim 13, wherein the first gaseous detector is fixed to a surgery table.

15. A surgical installation according to claim 14, wherein the first gaseous detector is supported by a frame which is removably fixed to the surgery table.

16. A surgical installation according to claim 15, wherein said frame includes a head support adapted to support the head of a patient during cerebral surgery.

17. A surgical installation according to claim 15, wherein said frame includes a collimator interposed between said first gaseous detector and said head support.

18. A surgical installation according to claim 14, wherein the imaging device further includes a second gaseous detector similar to said first gaseous detector and having a second detection direction, said second gaseous detector being mounted to the surgery table so that the second detection direction may be oriented toward the surgical table at an angle with said first detection direction, said second gaseous detector communicating with the display device and said display device being able to compute a three dimension image at least from images taken by said first and second gaseous detectors.
